(19) United States
(12) Patent Application Publication
(10) Pub. No.: US 2008/0229183 A1
(43) Pub. Date: Sep. 18, 2008

(54) RECORDING MEDIUM IN WHICH ACCESS OUTCOME FEEDBACK IS RECORDED, ACCESS OUTCOME FEEDBACK METHOD, ACCESS OUTCOME FEEDBACK APPARATUS, AND TERMINAL APPARATUS

(75) Inventor: Hirotaka SHIMIZU, Yokohama (JP)

Correspondence Address: STAAS & HALSEY LLP, SUITE 700, 1201 NEW YORK AVENUE, N.W., WASHINGTON, DC, 20005, US

(73) Assignee: FUJITSU LIMITED, Kanagawa (JP)

(21) Appl. No.: 12/045,341

(22) Filed: Mar. 10, 2008

(30) Foreign Application Priority Data
Mar. 15, 2007 (JP) JP2007-067350

(51) Int. Cl. G06F 17/00

(52) U.S. Cl. 715/207

(57) ABSTRACT

An access outcome feedback method for determining a jump destination sorting ratio which is a ratio for jumping to each of plural sites, the plural sites becoming a jump destination of a specified hyperlink and storing identical contents, apparatus, and recording medium. The method includes acquiring a download outcome of the contents, the download being performed by the terminal apparatus jumping to the one site. The method also includes determining whether a site whose download failure frequency is equal to or higher than a predetermined threshold exists in the plural site based on the acquired download outcome.

### CROSS-REFERENCE TO RELATED APPLICATIONS

This application is related to and claims the benefit of Japanese Patent Application No. 2007-67350, filed Mar. 15, 2007, in the Japanese Intellectual Property Office, the entire contents of which are incorporated herein by reference.

### BACKGROUND

1. Field

An embodiments relate to feedback and an access outcome feedback method.

2. Description of Related Art

In some cases, plural sites in which the same data can be stored are correlated with one another in a hyperlink linked to a WEB site published by a WEB server, and the sites which become a jump destination when the hyperlink is specified are dispersed to reduce a processing load of the WEB server. The site becoming the jump destination is determined according to a predetermined ratio (hereinafter referred to as “jump destination sorting ratio”) such that the site having the higher ratio becomes preferentially the jump destination.

For example, techniques have been proposed, wherein pieces of load information on a main server and a mirror server providing a broadcast program home page are periodically collected, arbitrary URL information is extracted from a server URL table changed according to the load information on each server, and connection to the program home page is controlled according to the arbitrary URL information.

However, in the technique, even in the case where obstacle unexpected by a WEB server manager such as malfunction and traffic convergence of a computer apparatus in which the site becoming the jump destination is placed, the site becoming the jump destination is determined according to the predetermined jump destination sorting ratio. Therefore, the guide to a proper jump destination cannot be performed in some cases.

### SUMMARY

According to an aspect of an embodiment, an access outcome feedback method can include receiving a request to transmit data concerning a site becoming a jump destination of the hyperlink, the request being transmitted from a terminal apparatus accepting specification of the hyperlink.

According to an embodiment an access outcome feedback method can include selecting one site from the plural sites according to the jump destination sorting ratio when the transmission request is received.

According to an embodiment an access outcome feedback method can include transmitting data in which the selected site is specified as the jump destination to the terminal apparatus and acquiring a download outcome of the contents, the download being performed by the terminal apparatus jumping to the one site according to the transmitted data.

According to an embodiment an access outcome feedback a method can include determining whether a site whose download failure frequency is equal to or higher than a predetermined threshold exists in the plural site based on the acquired download outcome and when the determination that the site whose download failure frequency is equal to or higher than the predetermined threshold exists is made in the determination operation, updating the jump destination sorting ratio to lower the ratio for jumping to the site whose download failure frequency is equal to or higher than the predetermined threshold.

Additional aspects and/or advantages will be set forth in part in the description which follows and, in part, will be apparent from the description, or may be learned by practice.

### BRIEF DESCRIPTION OF THE DRAWINGS

These and/or other aspects and advantages will become apparent and more readily appreciated from the following description of an embodiments, taken in conjunction with the accompanying drawings of which:

FIG. 1 is block diagram illustrating a diagram illustrating an access outcome feedback system according to an embodiment

FIG. 2 is a block diagram illustrating a hardware configuration of a computer apparatus according to an embodiment;

FIG. 3 is a diagram illustrating a DL site guide ratio setting DB according to an embodiment;

FIG. 4 is a diagram illustrating a failure history table according to an embodiment;

FIG. 5 is a diagram illustrating a setting DB according to an embodiment;

FIG. 6 is a block diagram illustrating an access outcome feedback system of an embodiment;

FIG. 7 is a diagram illustrating a DL site selection method according to an embodiment;

FIG. 8 is a diagram illustrating an example of a display screen of a client terminal according to an embodiment;

FIG. 9 is a block diagram illustrating example access outcome feedback processing in an access outcome feedback system of an embodiment;

FIG. 10 is a flowchart illustrating a WEB server processing procedure;

FIG. 11 is a flowchart illustrating another WEB server processing procedure; and

FIG. 12 is a flowchart illustrating another WEB server processing procedure.

### DETAILED DESCRIPTION OF THE PREFERRED EMBODIMENTS

Reference will now be made in detail to an embodiments, examples of which are illustrated in the accompanying drawings, wherein like reference numerals refer to the like elements throughout. An embodiments are described below to explain the present invention by referring to the figures.

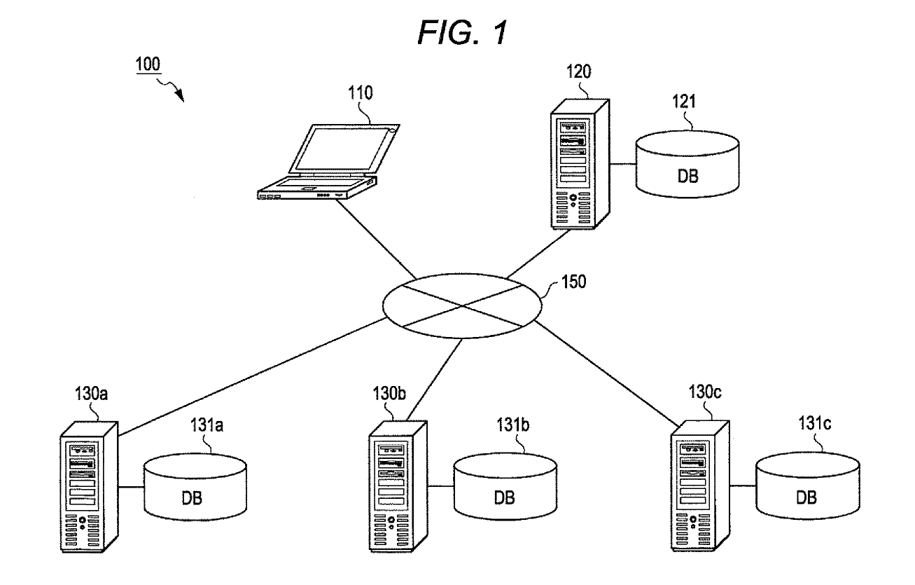

FIG. 1 is a diagram illustrating an access outcome feedback system of an embodiment.

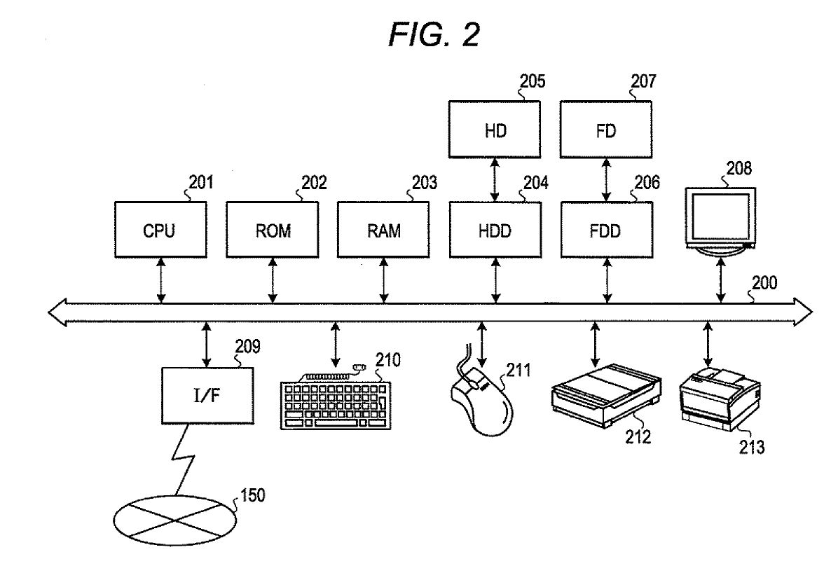

Referring to FIG. 1, an access outcome feedback system 100 of an embodiment can include a client terminal 110, a WEB server 120, and an FTP (File Transfer Protocol) servers 130a, 130b, and 130c. In the access outcome feedback system 100, the client terminal 110, WEB server 120, and FTP servers 130a, 130b, and 130c can be connected while being able to communicate with one another through a communication network 150 such as the Internet. Each of the client terminal 110, WEB server 120, and FTP servers 130a, 130b, and 130c are a computer apparatus (see FIG. 2).

The client terminal 110 can access a WEB site published on WEB by the WEB server 120 through the communication network 150. Using the client terminal 110, a user of the client terminal 110 can browse the WEB site by accessing the WEB site published on WEB by the WEB server 120.

The client terminal 110 can access the FTP servers 130a, 130b, and 130c through the communication network 150. Each FTP server 130a, 130b, and 130c can include a database (hereinafter referred to as “DB”) 131a, 131b, and 131c.

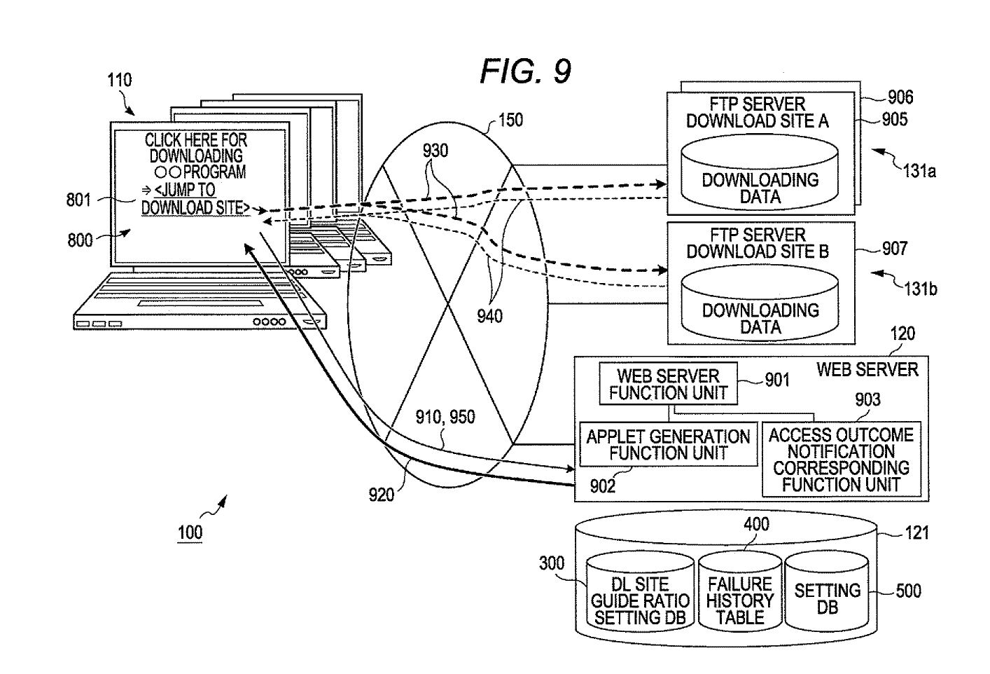

A download site (hereinafter referred to as “DL site”, see DL site 905 to 907 in FIG. 9) is provided in each DB 131a, 131b, and 131c. Each DL site can be specified by URL (Uniform Resource Locator) corresponding to each DL site. Download data (hereinafter referred to as “DL data”) is placed in each DL site.

Examples of the DL data include image data, text data, and various kinds of program data. The client terminal 110 can download the DL data placed on the DL site of the specified DB 131a, 131b, and 131c through each FTP servers 130a, 130b, and 130c.

The WEB server 120 is a computer apparatus including DB 121, and the WEB server 120 publishes the WEB site on WEB using various pieces of data stored in DB 121. The WEB server 120 transmits data for displaying a home page (hereinafter referred to as “HP”) of the WEB site to the client terminal 110 which makes an access request.

The WEB server 120 transmits data for displaying a hyperlink on a display 208 (see FIG. 2) of the client terminal 110. The hyperlink can include URL specifying the DL site on which the DL data is placed.

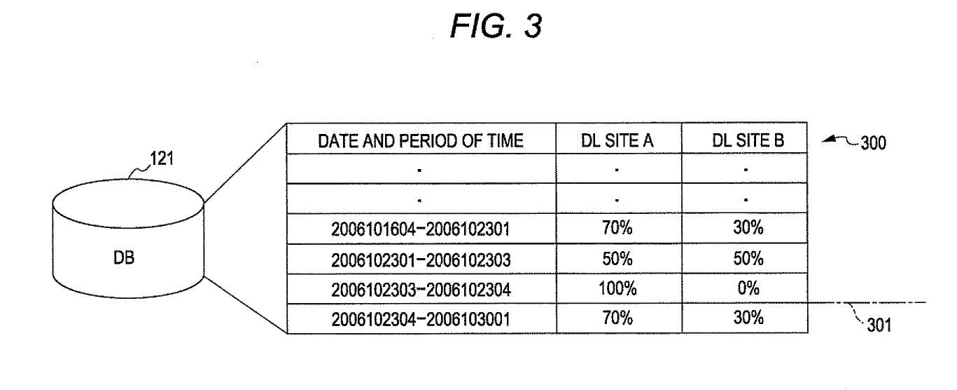

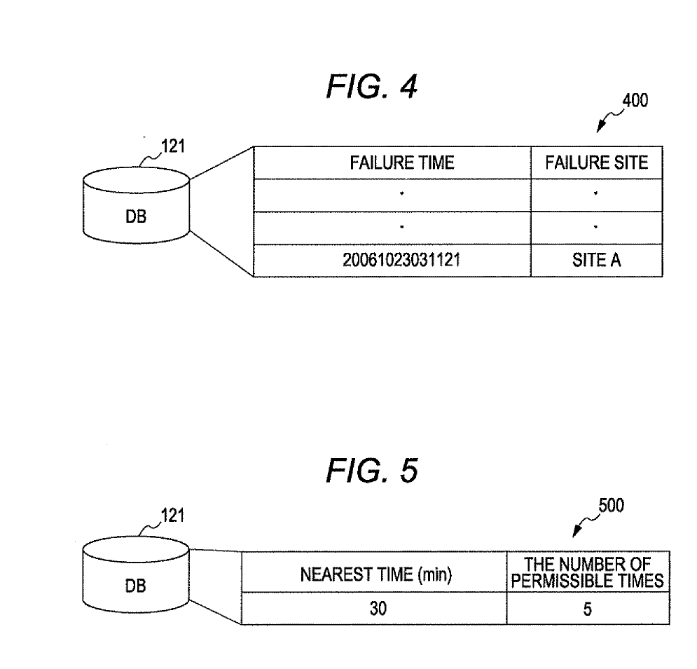

For example, a DL site guide ratio setting DB 300 (see FIG. 3), a failure history table 400 (see FIG. 4), and a setting DB (seethe numeral 500 in FIG. 5) are stored in DB 121 in addition to the data published on the WEB site.

In the access outcome feedback system 100, the WEB server 120 and the FTP servers 130a, 130b, and 130c are not always formed by different pieces of apparatus, but the WEB server 120 and the FTP servers 130a, 130b, and 130c may be formed by the same apparatus. In this case, for example, various DL sites stored in DB 131 of the FTP server 130 is provided in DB 121 of the WEB server 120, and the client terminal 110 may access the DL site through the WEB server 120. Alternatively, the function equivalent to the WEB server 120 and DB 121 may be realized by the FTP server 130 and DB 131.

In the access outcome feedback system 100, the number of client terminals 110 is not limited to one, but plural client terminals 110 may exist. In this case, the WEB site published on WEB by the WEB server 120 can be accessed by the unspecified number of client terminals 110. In an embodiment, it is assumed that the plural client terminals 110 exist in the access outcome feedback system 100.

In the access outcome feedback system 1001 the number of WEB servers 120 is not limited to one, but plural WEB servers 120 may exist. In this case, the client terminal 110 can be connected to any one of the plural WEB servers 120, and the client terminal 110 can access any WEB site published on WEB by the WEB servers 120.

In the access outcome feedback system 100, the number of FTP servers 130 (130a, 130b, and 130c) are not limited to three, but one, two, or four or more FTP servers 130 may exist. The DL site may be operated by one or plural FTP servers 130 (130a, 130b, and 130c) through the FTP servers 130a, 130b, and 130c.

FIG. 2 is a block diagram illustrating the hardware configuration of the computer apparatus of an embodiment.

Referring to FIG. 2, the computer apparatus can include CPU 201, ROM 202, RAM 203, HDD (hard disk drive) 204, HD (hard disk) 205, FDD (flexible disk drive) 206, FD (flexible disk) 207 which is an example of a detachable recording medium, a display 208, I/F (interface) 209, a keyboard 210, a mouse 211, a scanner 212, and a printer 213. The components can be connected to one another through a bus 200.

CPU 201 can control the entire operation of the computer apparatus. Programs such as a boot program are stored in ROM 202. RAM 203 can be used as a work area of CPU 201. HDD 204 can control data read/write for HD 205 under the control of CPU 201. Data written by the control of HDD 204 can be stored in HD 205.

FDD 206 can control data read/write for FD 207 under the control of CPU 201. Data written by the control of FDD 206 can be stored in FD 207, and the data stored in FD 207 can be read by the computer apparatus.

For example, CD-ROM (CD-R, CD-RW), MO, DVD (Digital Versatile Disk), and a memory card may be used as the detachable recording medium in addition to FD 207. The display 208 displays pieces of data such as a cursor, an icon, a tool box, a document, an image, and functional information. For example, CRT, a TFT liquid crystal display, and a plasma display can be used as the display 208.

I/F 209 is connected to the communication network 150 and connected to other devices through the communication network 150. I/F 209 acts as an interface between the communication network 150 and the inside of the computer apparatus, and I/F 209 can control data input and output with an external device. For example, a modem and a LAN adapter can be used as I/F 209.

The keyboard 210 can include keys for inputting characters, numeric characters, and various instructions to input data. A touch-panel input pad or ten keys may be provided instead of or in addition to the keyboard 210. The mouse 211 performs the movement or range selection of the cursor or the movement or size change of a window. A track ball and a joystick may be used instead of the mouse 211 as long as the similar function is provided as the pointing device.

The scanner 212 optically reads an image to capture image data in the computer apparatus. An OCR function may be provided in the scanner 212. The printer 213 prints image data or document data. For example, a laser printer or an inkjet printer can be used as the printer 213.

An example DL site guide ratio setting DB in the access outcome feedback system 100 of an embodiment will be described below with reference to FIG. 3. FIG. 3 is a diagram illustrating of the DL site guide ratio setting DB of an embodiment.

As illustrated in FIG. 3, a DL site guide ratio setting DB 300 can be stored in DB 121. The DL site guide ratio setting DB 300 is a database in which a jump destination sorting ratio can be stored for each date and period of time. The jump destination sorting ratio is a ratio for jumping to each of plural sites, in which the same contents are stored, becoming a jump destination of a specified hyperlink.

The jump destination sorting ratio concerning a DL site A and a DL site B (see data transmissions 905 and 907 in FIG. 9), in which the same DL data can be stored, is illustrated in FIG. 3. The jump destination sorting ratio is updated for each date and period of time according to the access outcome in the client terminal 110 having tried to access the DL site A or DL site B. The jump destination sorting ratio is dynamically updated according to the access outcome of the client terminal 110 having tried to access the DL site A or DL site B, and the jump destination sorting ratio is undetermined for the current time and the future date and period of time.

FIG. 3 illustrates a DL site guide ratio setting DB 300 in the case where the current clock time is included in a period between 04:00 on Oct. 23, 2006 and 01:00 on Oct. 30, 2006. For example, in the case where the current clock time is 03:30 Oct. 23, 2006, the jump destination sorting ratios located above an alternate long and short dash line designated by the numeral 301 of FIG. 3 are stored in the DL site guide ratio setting DB 300, and the jump destination sorting ratios located below the alternate long and short dash line 301 are undetermined.

The jump destination sorting ratio indicates a ratio of successful access when the client terminal 110 requesting the DL data download tries to access to the DL site. In FIG. 3, when the current clock time is 03:30 Oct. 23, 2006, the jump to the DL site B cannot be performed because the jump destination sorting ratio of the DL site A becomes 100% in the corresponding date and period of time.

An example failure history table in the access outcome feedback system 100 of an embodiment will be described below with reference to FIG. 4. FIG. 4 is a diagram illustrating of the failure history table of an embodiment. In FIG. 4, a failure history table 400 can be stored in DB 121 of FIG. 1. The failure history table 400 is a data table in which a DL site (for example, see the numerals 905 and 907 in FIG. 9) becoming the jump destination of the hyperlink specified in the client terminal 110 and the access outcome to the DL site are stored.

As illustrated in FIG. 4, in the failure history table 400, the DL site becoming the jump destination of the hyperlink specified in the client terminal 110 and the clock time when the access to the DL site is failed are stored while correlated with each other. The clock time when the access to the DL site becoming the jump destination is failed can be specified by a clock time when the client terminal 110 receives a failure notification of the access to the DL site becoming the jump destination of the hyperlink specified in the client terminal 110.

An example setting DB in the access outcome feedback system 100 of an embodiment will be described below with reference to FIG. 5. FIG. 5 is a diagram illustrating of the setting DB of an embodiment. In FIG. 5, a setting DB 500 can be stored in DB 121 of FIG. 1. The setting DB 500 is a database in which a predetermined period in the past from the current clock time (see “nearest time (min)” in FIG. 5) and the permissible number of times of the download failure within the nearest time (hereinafter referred to as “the permissible number of times”) are stored.

The nearest time and the permissible number of times can arbitrarily be set by a manager of the access outcome feedback system 100. In FIG. 5, the nearest time is set to 30 minutes and the permissible number of times is set to five (times).

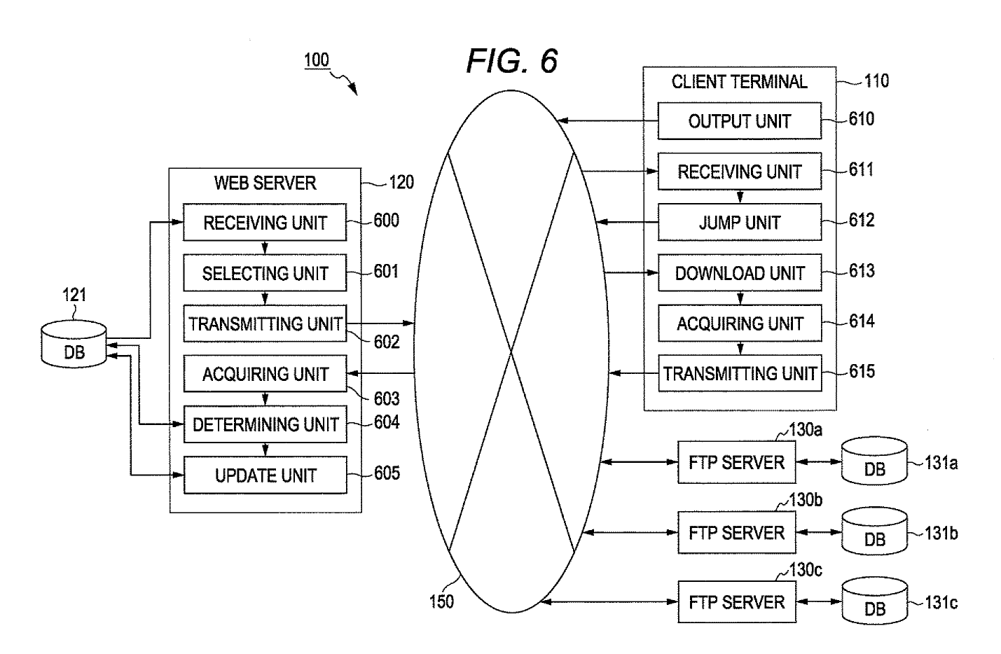

An example access outcome feedback system 100 of an embodiment will be described with reference to FIG. 6. FIG. 6 is a diagram illustrating the functional configuration of the access outcome feedback system of an embodiment.

Referring to FIG. 6, the WEB server 120 in the access outcome feedback system 100 of an embodiment can include a reception portion 600, a selection portion 601, a transmission portion 602, an acquisition portion 603, a determination portion 604, and an update portion 605.

The reception portion 600 receives a request of the DL site becoming the jump destination of the hyperlink. The request of the DL site is transmitted from the client terminal 100 accepting the specification of the hyperlink. The selection portion 601 selects one of the plural DL sites according to the jump destination sorting ratio in the DL site guide ratio setting DB 300, when the reception portion 600 have received the request of the DL site. The selection portion 601 selects one DL site according to the jump destination sorting ratio in the date and period of time including a current clock time t1.

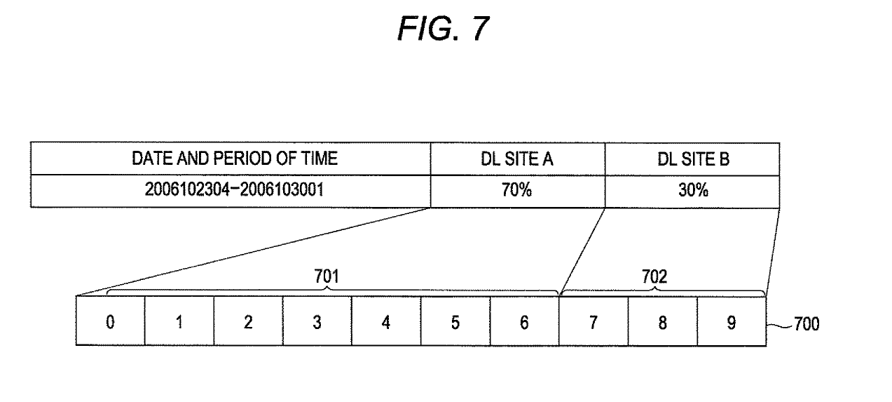

A DL site selection method in the access outcome feedback system 100 of an embodiment will be described with reference to FIG. 7. FIG. 7 is a diagram explaining the DL site selection method of an embodiment. In FIG. 7, the DL site selection method in which the DL site is selected at the current clock time t1 of 04:30:56 on Oct. 23, 2006 is described using the DL site guide ratio setting DB 300 of FIG. 3.

In selecting the DL site, the jump destination sorting ratios of the DL sites A and B are acquired in the date and period of time including the current clock time t1. In the DL site guide ratio setting DB 300 of FIG. 3, the jump destination sorting ratio of the DL site A is set to 70% and the jump destination sorting ratio of the DL site B is set to 30%.

Each of a group 700 of integers 0 to 9 is allocated to the DL site A or B according to the acquired jump destination sorting ratio. In the DL site guide ratio setting DB 300 of FIG. 3, a group 701 of integers 0 to 6 is allocated to the DL site A and a group 702 of integers 7 to 9 is allocated to the DL site B.

Then, it is specified which integer in the group 700 of integers 0 to 9 corresponds to a numerical value of the last one digit in a numerical value indicating the number of seconds at the current clock time t1. Because the current clock time t1 is 04:30:56 on Oct. 23, 2006 as described above, “6” is specified as the corresponding integer in an embodiment. The DL site to which the specified integer is allocated is selected as the DL site of the jump destination.

The DL site can be selected simply and properly, when the DL site is selected using the number of seconds at the current clock time t1 and the group 700 of integers 0 to 9 at the time the DL site is selected. When the DL site is selected using the number of seconds at the current clock time and the group 700 of integers 0 to 9 at the time the DL site is selected, a bias in the probability that a particular DL site is selected can be prevented to reduce the load on the processing compared with the case in which a pseudo-random number is generated to select the DL site.

When the DL site is selected using the number of seconds at the current clock time and the group 700 of integers 0 to 9 at the time the DL site is selected, the WEB server 120 does not need to analyze the number of client terminals 110 having made the request to select the DL site, so that the increase in processing load can be prevented in the WEB server 120.

In an embodiment, the DL site is selected using the numerical value indicating the last one digit of the number of seconds at the current clock time. The DL site selection method is not limited to an embodiment. The DL site may be selected using the numerical value existing with the same probability at the time the determination of the DL site is requested. Specifically, for example, the DL site may be selected using the numerical value indicating the first decimal place in the number of seconds at the current clock time.

When the DL site is selected using the numerical value indicating the first decimal place in the number of seconds at the current clock time, the DL site can properly be selected for each client terminal 110 even if the plural client terminals 110 try to access in an extremely short time (for example, several seconds).

The transmission portion 602 transmits data for specifying the DL site selected by the selection portion 601 as the jump destination to the client terminal 110. The transmission portion 602 transmits data for specifying the DL site as the jump destination to the client terminal 110 having requested the selection of the DL site.

The acquisition portion 603 acquires the download outcome of the downloading data according to the data transmitted by the transmission portion 602. The download of the download data is performed by the client terminal 110 jumping to the DL site selected by the selection portion 601. As used herein, the download outcome shall mean data which can determine whether the download performed by each client terminal 110 is normally ended. For example, the acquisition portion 603 acquires data indicating the time between the start and completion of the download in the client terminal 110.

The determination portion 604 determines whether the DL site whose download failure frequency is equal to or higher than a predetermined threshold exists in the plural DL site based on the download outcome acquired by the acquisition portion 603. As used herein, the predetermined threshold shall mean a value for determining the download failure frequency. For example, the predetermined threshold is expressed by the number of times of the download failure such as “five times”.

The predetermined threshold may be a value, such as “five times in a day” and “five times in a day including the current clock time and going back from the current clock times”, for specifying the date and period of time of the failure. The predetermined threshold is a value which can arbitrarily be set by a manager of the WEB server 120, and the predetermined threshold is a value which can appropriately be updated as time advances even if the predetermined threshold is set once.

The determination portion 604 may determine whether the DL site whose failure frequency is equal to or higher than the predetermined threshold exists in all the DL sites in which the same DL contents are stored, or the determination portion 604 may determine whether the failure frequency is equal to or higher than predetermined threshold for each DL site.

The update portion 605 updates the jump destination sorting ratio in the DL site guide ratio setting DB 300 when the determination portion 604 has determined that the DL site whose failure frequency is equal to or higher than the predetermined threshold exists. The update portion 605 updates the jump destination sorting ratio so as to reduce the ratio jumping to the DL site whose failure frequency is determined to be equal to or higher than the predetermined threshold.

In the WEB server 120, the jump destination sorting ratio of the DL site guide ratio setting DB 300 can be updated according to the failure frequency of the DL data download performed by the client terminal 110. That is, the jump destination sorting ratio of the DL site guide ratio setting DB 300 can be updated according to a communication status on the communication network 150, even if the obstacle unexpected by the manager of the WEB server 120, such as the malfunction and traffic convergence of the FTP server 130 in which the DL site becoming the jump destination is placed, is generated.

In the WEB server 120, the period during which the DL site becomes the monitoring target of the download failure frequency is limited, and the jump destination sorting ratio of the DL site guide ratio setting DB 300 is updated based on whether the DL site whose failure frequency is equal to or higher than the predetermined threshold in the predetermined period exists. Therefore, the DL site guide ratio setting DB 300 can efficiently be managed, and the processing load applied on the management can be reduced.

In the WEB server 120, the period during which the DL site becomes the monitoring target of the download failure frequency is limited to the nearest period including the current clock timer and the jump destination sorting ratio of the DL site guide ratio setting DB 300 is updated based on whether the DL site whose failure frequency is equal to or higher than the predetermined threshold in the predetermined period including the current clock time exists. Therefore, the DL site guide ratio setting DB 300 can efficiently be managed, and the processing load applied on the management can be reduced. Additionally, the jump destination sorting ratio can be updated in real time according to the communication status on the communication network 150.

In the WEB server 120, the jump destination sorting ratio can be updated according to the communication status for each DL site by determining whether the DL site whose failure frequency is equal to or higher than the predetermined threshold exists for each DL site of the plural DL sites.

In the WEB server 120, the jump destination sorting ratio is updated so as to reduce the ratio jumping to the DL site whose failure frequency is equal to or higher than the predetermined threshold. Therefore, the client terminal 110 can jump easily to the DL site.

As illustrated in FIG. 6, the client terminal 110 in the access outcome feedback system 100 of an embodiment can include an output portion 610, a reception portion 611, a jump portion 612, a download portion 613, an acquisition portion 614, and a transmission portion 615.

The output portion 610 outputs the request to transmit the data concerning the site becoming the jump destination of the specified hyperlink to the WEB server 120. The reception portion 611 receives the data concerning the jump destination sorting ratio in response to the output of the output portion 610. The data concerning the jump destination sorting ratio is transmitted from the WEB server 120. The data concerning the jump destination sorting ratio is received along with the browsing data when the browsing data for browsing HP in the WEB site published on the communication network 150 through the WEB server 120 is downloaded into the client terminal 110.

The jump portion 612 jumps to one (for example, DL site A or DL site B) of the plural DL sites according to the data received by the reception portion 611. The download portion 613 downloads the DL data from the DL sites to which the jump portion 612 jumps. The descriptions of the jump of the jump portion 612 to one of the DL sites and the download of the DL data performed by the download portion 613 are not given here because they are known technique.

The acquisition portion 614 acquires the download outcome performed by the download portion 613. The download outcome shall mean data indicating whether the download performed in each client terminal 110 is normally ended.

For example, in downloading the DL data formed by plural packets, the download outcome is the data indicating the total number of packets and the number of packets in which the download is already completed to the client terminal 110. It is assumed that the download outcome can include the data indicating the time between the start and completion of the download outcome. The transmission portion 615 transmits the download outcome acquired by the acquisition portion 614 to the WEB server 120.

The client terminal 110 can notify the WEB server 120 of the communication status on the communication network 150, even if the obstacle unexpected by the manager of the WEB server 120, such as the malfunction and traffic convergence of the FTP server 130 becoming the jump destination, is generated.

That is, the WEB server 120 individually conducts communication with each FTP server 130, and the WEB server 120 can recognize the communication status of each FTP server 130 through the communication with the client terminal 110 with which the WEB server 120 needs originally to conduct communication, while WEB server 120 dose not manage the communication status of each FTP server 130. Therefore, the client terminal 110 can jump to the easy-to-jump destination.

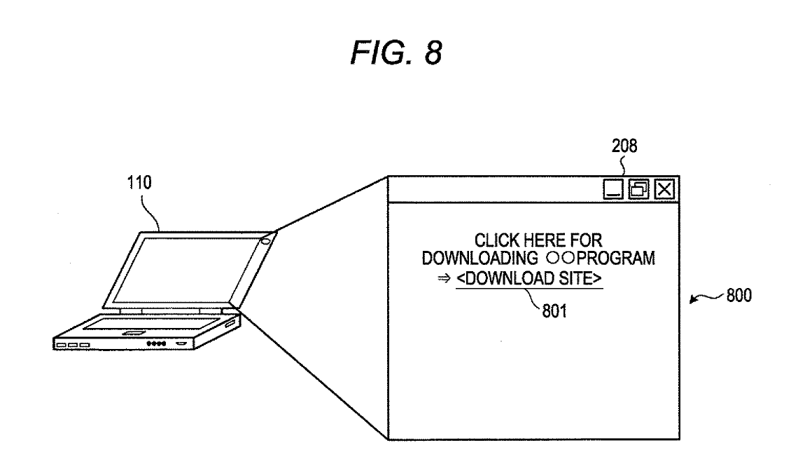

A display screen of the client terminal 110 in the outcome feedback system 100 of an embodiment will be described with reference to FIG. 8. FIG. 8 is a diagram illustrating an example of the display screen of the client terminal 110 of an embodiment.

In FIG. 8, a display screen 800 is displayed on the display 208 of the client terminal 110. A hyperlink 801 expressed by <download site> is displayed on the display screen 800 of FIG. 8. The hyperlink 801 is data described in an html format. The data can include URL specifying the DL site (for example, see the DL site A or DL site B) in which the DL data for downloading “OO program” can be stored and an applet which downloads the DL data from the DL site becoming the jump destination while causing the client terminal 110 to jump to the DL site according to URL.

The applet included in the hyperlink 801 displayed on the display screen 800 can be executed, when a user of the client terminal 110 manipulates the keyboard 210 or mouse 211 of FIG. 2 to select the hyperlink 801.

A principle configuration of access outcome feedback processing in the access outcome feedback system 100 will be described below. FIG. 9 is a diagram illustrating the principle configuration of the access outcome feedback processing in the access outcome feedback system 100 of an embodiment. In FIG. 9, the numerals 910, 920, 930, 940, and 950 designate a data transmission and direction and an example transmission order in the access outcome feedback system 100.

The client terminal 110 provides a request of data for downloading “OO program” to the WEB server 120 (see data transmission 910 in FIG. 9) when the hyperlink 801 displayed on the display 208 of the client terminal 110 is selected.

Then, the WEB server 120 transmits a response to the client terminal 110 (see data transmission 920 in FIG. 9) when having received the request provided from the client terminal 110. The response can include URL of the DL site in which the DL data for executing “OO program” in the client terminal 110 is placed and the applet for downloading the DL data from the DL site becoming the jump destination while causing the client terminal 110 to jump to the DL site according to the URL.

A WEB server function portion 901 included in the WEB server 120 realizes the transmission of the response. The response transmission function realized by the WEB server function portion 901 is not explained here because the response transmission function can be realized by the known technique included in the existing WEB server. In realizing the response transmission function, the applet is generated by an applet generating function portion 902 included in the WEB server 120.

The applet generating function portion 902 realizes a function of editing the applet, described pursuant to the http data format, into which URL of the DL site is incorporated and a function of compiling the edited applet. The data for setting various conditions in the applet generated by the applet generating function portion 902 can be stored in the setting DB 500.

The applet generating function portion 902 edits the applet according to various conditions stored in the setting DB 500, and the applet generating function portion 902 compiles the edited applet in the format in which the applet can be executed in the client terminal 110. The WEB server function portion 901 transmits the applet compiled by the applet generating function portion 902 to the client terminal 110.

Then, the client terminal 110 displays the display screen 800, for example on the display 208, (see data transmission 930 in FIG. 9) when having received the response transmitted from the WEB server 120. When the hyperlink 801 displayed on the display screen 800 is selected, the client terminal 110 executes the applet included in the response to access the DL site (in this case, DL site A905) indicated by URL included in the response, and the client terminal 110 starts the download of the DL data in the DL site A905 (see data transmission 940 in FIG. 9).

Although FIG. 9 illustrates the state in which the DL data is downloaded from the DL site A905 and DL site B907, the DL data downloaded in each time is provided from either the DL site A905 or the DL site B907.

When the hyperlink 801 displayed on the display screen 800 is selected, the client terminal 110 detects the clock time t1 when the hyperlink 801 is selected, and the client terminal 110 stores data expressing the detected clock time t1 in RAM 203. Both the download of the DL data download and detection of the clock time t1 can be realized by executing the applet included in the response.

The client terminal 110 determines whether DL normal end indicating the normal end of the DL data download is detected while performing the DL data download, and the client terminal 110 continuously performs the download until the DL normal end is detected. The method for determining whether the DL normal end is detected is not explained here because it is a known technique. The client terminal 110 normally ends the download when having detected the DL normal end until a predetermined time elapses since the clock time t1.

When the connection between the client terminal 110 and the DL site A905 is disconnected before the DL normal end is detected, or when the DL normal end is not detected until the predetermined time elapses since the clock time t1, the client terminal 110 transmits an access failure notification indicating failure of the access to URL of the DL site A905 to the WEB site 120, and the client terminal 110 transmits a request to transmit URL of another DL site 950 (see data transmission 950 in FIG. 9).

An access outcome notification corresponding function portion 903 in the WEB server 120 refers to the DL site guide ratio setting DB 300 to select URL of another DL site (in this case, DL site B907) different from the DL site A905 when having received the access failure notification transmitted from the client terminal 110.

When the DL site guide ratio setting DB 300 selects URL of the DL site B907, the applet generating function portion 902 realizes the function of editing the applet, described pursuant to the http data format, into which URL of the DL site B907 is incorporated and the function of compiling the edited applet. In this case, the applet generating function portion 902 also edits and compiles the new applet according to the setting conditions stored in the setting DB 500. The WEB server function portion 901 transmits the newly edited and compiled applet to the client terminal 110.

The client terminal 110 waits for URL included in the new applet of the DL site B907. When the client terminal 110 has received URL, the client terminal 110 accesses URL of the DL site B907 to start the DL data download placed in the DL site B907. The DL data download placed in the DL site B907 is similar to that of the DL site A905, so that the description is not given here.

The access outcome notification corresponding function portion 903 updates the failure history table 400 when the access failure notification transmitted from the client terminal 110 is received. Specifically, the access outcome notification corresponding function portion 903 records the failure of the access to the DL site and the clock time of the access failure in the failure history table 400. The access outcome notification corresponding function portion 903 updates the failure history table 400 by adding the data to the failure history table 400 during the predetermined period.

The access outcome notification corresponding function portion 903 determines whether the access failure notification transmitted from the client terminal 110 is equal to or higher than the predetermined threshold according to the setting DB 500 when having updated the failure history table 400. The access outcome notification corresponding function portion 903 determines whether the access failure notification transmitted from the client terminal 110 is equal to or higher than the predetermined threshold for each FTP server 130.

When the access failure notification transmitted from the client terminal 110 is equal to or higher than the predetermined threshold, the access outcome notification corresponding function portion 903 updates the jump destination sorting ratio in the DL site guide ratio setting DB 300. At this point, the access outcome notification corresponding function portion 903 updates the jump destination sorting ratio so as to reduce the jump destination sorting ratio in the FTP server 130 whose access failure notification is equal to or higher than the predetermined threshold.

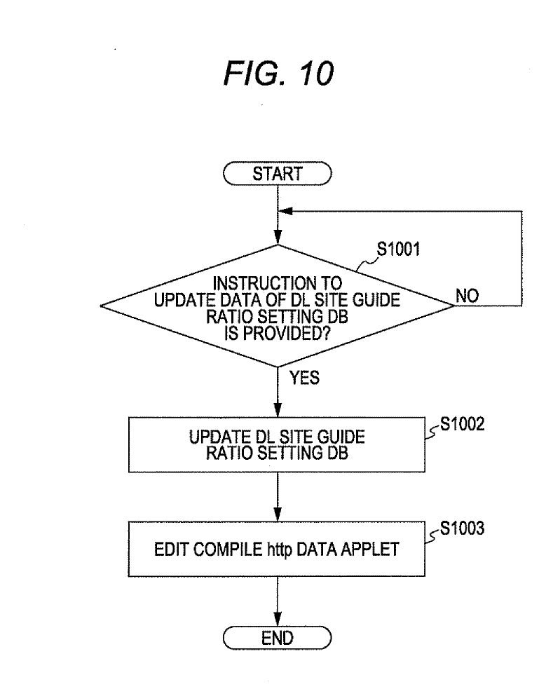

An example processing procedure performed by the WEB server 120 will be described below. FIG. 10 is a flowchart illustrating a processing procedure performed by the WEB server 120. In FIG. 10, the WEB server 120 waits for an instruction to update the data in the DL site guide ratio setting DB 300 (No in Operation SI 001). For example, the instruction to update the data in the DL site guide ratio setting DB 300 is issued when the access outcome notification corresponding function portion 903 determines that the access failure notification transmitted from the client terminal 110 is equal to or higher than the predetermined threshold.

In Operation S1001, when the data update instruction is issued (Yes in Operation S1001), the access outcome notification corresponding function portion 903 updates the DL site guide ratio setting DB 300 (Operation S1002), the applet generating function portion 902 edits and compiles the applet based on the updated DL site guide ratio setting DB 300 (Operation S1003), and the series of processing is ended.

In the processing procedure performed by the WEB server 120), the applet is edited and compiled every time the DL site guide ratio setting DB 300 is updated. The edited and compiled applet can be stored in a predetermined memory, so that the applet requested from the client can rapidly be provided while the processing load is reduced in providing the applet.

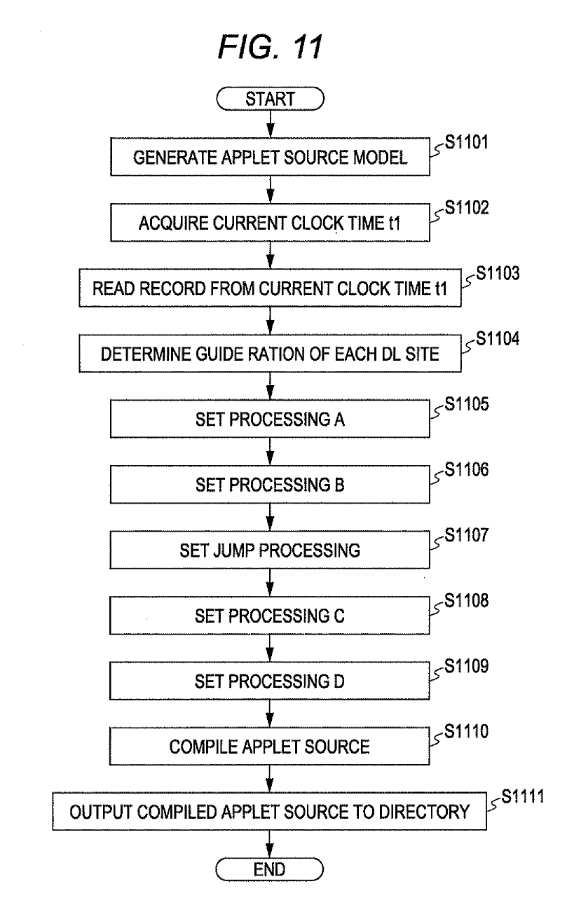

FIG. 11 is a flowchart illustrating a processing procedure performed by the WEB server 120. The processing procedure illustrated in FIG. 11 can be performed during Operation S1003 illustrated in FIG. 10.

In FIG. 11, an applet source model is produced (Operation S1101), and a clock time (hereinafter referred to as “current clock time t1”) when the applet is edited and compiled is acquired (Operation S1102). A record after a date and period of time including the current clock time t1 can be read in the DL site guide ratio setting DB 300 (Operation S1103), and a guide ratio of the DL site A905 and DL site B907 is determined (Operation S1104). In Operation S1104, the jump destination sorting ratio of the DL site A905 and DL site B907 is determined as the guide ratio of the DL site A905 and DL site B907 according to the record read in Operation S1103.

Then, processing A, processing B, jumping processing, processing C, and processing D are sequentially set in the applet source (Operations S1105 to S1109), the applet source in which the processing is set is compiled (Operation S1110), the compiled applet source is output to a directory (Operation S1111), and the series of processing is ended. As used herein, the directory shall mean a place where the data such as the compiled applet source which the WEB server 120 provides to the client terminal 110 is tentatively stored.

In the processing A of the processing procedure, when “jump to the download site” is selected in the client terminal 110, a current clock time CT is acquired at the time “jump to the download site” is selected, and the last one digit of the numerical value indicating the number of seconds of the acquired current clock time is extracted and set to a value TS. “Jump to the download site” is executed in the client terminal 110 and described as a character string in http data in the applet source model.

In the processing B of the processing procedure, that the processing A is performed “in each date and period of time TZ including the current clock time CT” is set as a branching condition in the client terminal 110,

In the jumping processing of the processing procedure,the integers 0 to 9 are allocated according to the guide ratio of the DL site A905 and the DL site B907 in the date and period of time TZ including the current clock time CT under the condition of the processing B in the client terminal 110 (see FIG. 7), and the client terminal 110 jumps to the DL site (DL site A905 or DL site B907) when the allocated numerical value is matched with the value TS.

In the processing C of the processing procedure, after the jumping processing, an elapsed time is measured in the client terminal 110 which has performed the jumping processing, and it is determined whether the jumping is completed within a predetermined time based on the measured time. A determination whether the download is completed within a predetermined time based on the measured time may be made in the processing C.

In the processing D of the processing procedure, when the determination that the jumping is not completed within the predetermined time is made in the processing C, the client terminal 110 transmits a DL failure server notification notifying that the download is failed in the FTP server 130 to which the client terminal 110 jumps to the WEB server 120, the client terminal 110 accepts the data concerning a substitute DL site (new DL site) from the WEB server 120, and the client terminal 110 jumps to the new DL site.

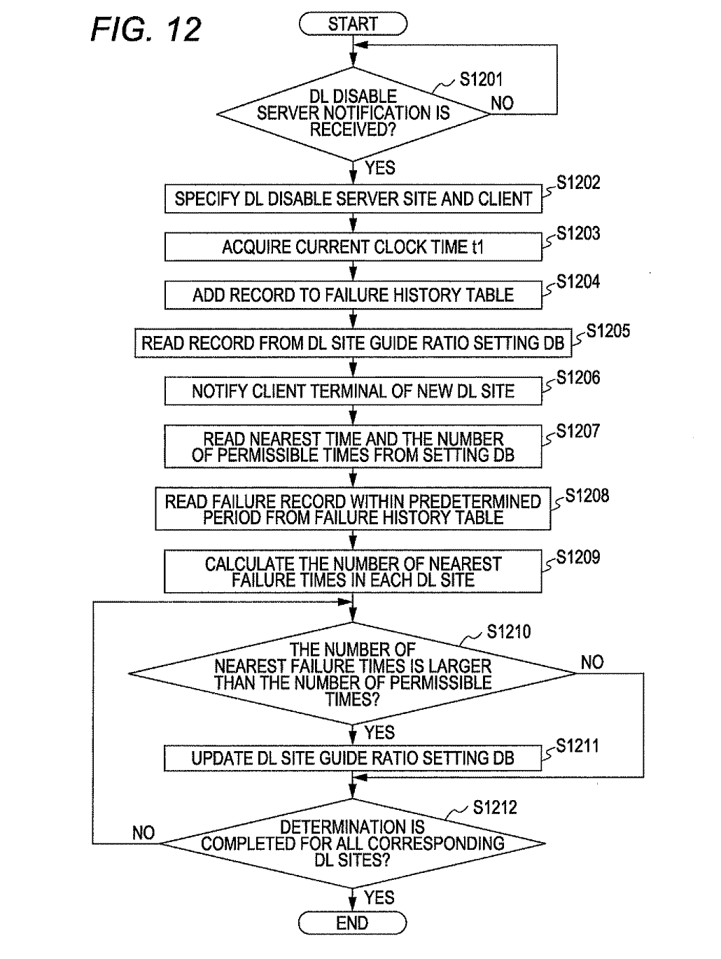

Then, a processing procedure performed by the WEB server 120 will be described. FIG. 12 is a flowchart illustrating the processing procedure performed by the WEB server 120. In FIG. 12, the WEB server 120 waits for reception of the DL failure server notification (No in Operation S1201). In Operation S1201 the WEB server 120 waits for reception of the DL failure server notification transmitted from the client terminal 110 to the WEB server 120 in the processing D.

In Operation S1201 when the DL failure server notification is received (Yes in Operation S1201), the site (“DL failure server site” in FIG. 12) placed in the DL failure server and the client transmitting the DL failure server notification are specified based on the DL failure server notification (Operation S1202), and the current clock time t1 is acquired (Operation S1203). In Operation S1203, the clock time when the DL failure server notification is received is acquired as the current clock time t1.

Then, the record is added to the failure history table 400 based on the DL failure server notification received in Operation S1201 and the current clock time t1 acquired in Operation S1203 (Operation S1204). In Operation S1204, the record in which the current clock time t1 acquired in Operation S1203 is set to a download failure clock time can be stored in the failure history table 400.

The record in which the current clock time t1 acquired in Operation S1203 is included in the date and period of time can be read from the DL site guide ratio setting DB 300 (Operation S1205), and the client terminal 110 is notified of the new DL site according to the read record (Operation S1206). In Operation S1206, the WEB server function portion 901 transmits the new applet source edited and compiled by the applet generating function portion 902 to the client terminal 110.

Then, the nearest time and the permissible number of times are read from the setting DB 500 (Operation S1207), the failure record within the predetermined time can be read from the failure history table 400 (Operation S1208), the number of nearest failure times is computed for each DL site (Operation S1209), and it is determined whether the computed number of nearest failure times is larger than the permissible number of times read in Operation S1207 (Operation S1210). When the computed number of nearest failure times is not larger than the permissible number of times (No in Operation S1210), the flow goes to Operation S1212.

When the computed number of nearest failure times is larger than the permissible number of times in Operation S1210 (Yes in Operation S1210), the DL site guide ratio setting DB 300 is updated (Operation S1211), and it is determined whether the determination in Operation S1210 is completed for all the corresponding DL sites (Operation S1212). When the determination is not completed for all the corresponding DL sites (No in Operation S1212), the flow returns to Operation S1210. When the determination is completed for all the corresponding DL sites (Yes in Operation S1212), the series of processing is ended.

Thus, according to an embodiment, the proper jump destination can be guided according to the jump destination sorting ratio which is updated depending on the failure frequency of the DL data download performed by the client terminal 110. Therefore, even if obstacle unexpected by the server manager such as the malfunction and traffic convergence of the FTP server 130 in which the DL sites A and B are placed is generated, a comfortable access environment can be provided to a user browsing the site according to the communication status on the communication network 150.

According to an embodiment, the target period during which the download failure frequency is monitored is limited, and it is determined whether the site whose download failure frequency is equal to or higher than the predetermined threshold within the predetermined period exists, so that the proper jump destination can be guided while the efficiency of the management and the decrease in processing load applied to the management are achieved in the DL site guide ratio setting DB 300 and the failure history table 400. Therefore, even if the obstacle unexpected by the manager of the WEB server 120 such as the malfunction and traffic convergence of the FTP server 130 is generated, the comfortable access environment can be provided to the user browsing the DL site A or DL site B according to the communication status on the communication network 150 while suppressing increase in processing load.

According to an embodiment, the target period during which the download failure frequency is monitored is limited to the nearest period including the current clock time t1, so that the proper jump destination can be guided in real time according to the communication status on the communication network 150 while the efficiency of the management and the decrease in processing load applied to the management are achieved. Therefore, the increase in processing load is suppressed in the WEB server 120, and the comfortable access environment can be provided to the user browsing the site according to the communication status on the communication network 150.

According to an embodiment, the determination whether the DL site whose failure frequency is equal to or higher than the predetermined threshold exists is made for each site, which allows the proper jump destination to be guided according to the communication status for each DL site. Therefore, even if an obstacle unexpected by the server manager such as the malfunction and traffic convergence of the computer apparatus in which the site becoming the jump destination is placed is generated, the client terminal can jump to the proper site, and the comfortable access environment can be provided to the user browsing the site.

According to an embodiment, the DL site guide ratio setting DB 300 is updated so as to decrease the jump destination sorting ratio of the DL site whose failure frequency is equal to or higher than the predetermined threshold. Therefore, the terminal apparatus can jump easily to the site and is guided to the proper jump destination.

Therefore, even if an obstacle unexpected by the manager of the WEB server 120 such as the malfunction and traffic convergence of the FTP server 130 in which the site becoming the jump destination is placed is generated, the client terminal 110 can jump to the site with a higher successful ratio and the comfortable access environment can be provided to the user browsing the site according to the communication status on the communication network 150.

According to an embodiment, even if an obstacle unexpected by the manager of the WEB server 120 such as the malfunction and traffic convergence of the FTP server 130 is generated, the client terminal 110 can notify the WEB server 120 of the communication status on the communication network 150. Therefore, even if the obstacle unexpected by the server manager such as the malfunction and traffic convergence of a computer apparatus in which the site becoming the jump destination is placed is generated, the client terminal 110 can jump to the easy-to-jump destination.

As described above, according to an embodiment, the comfortable access environment can be provided to the user browsing the DL site according to the communication status on the communication network 150.

As described above, according to an embodiment, the comfortable access environment can be provided to the user browsing the site according to the communication status on the communication network 150.

The access outcome feedback method of an embodiment can include executing the previously-prepared program using the computer such as a personal computer and a workstation. The program is recorded in a computer-readable recording medium such as a hard disk, a flexible disk, CD-ROM, MO, and DVD, and the program is executed by reading the program from the recording medium. The program may be a transfer medium which can be distributed through a network such as the Internet.

The WEB server 120 and client terminal 110 of an embodiment can also be realized by an application specific IC (hereinafter simply referred to as “ASIC”) such as a standard cell and a structured ASIC (Application Specific Integrated Circuit) or PLD (Programmable Logic Device) such as FPGA. Specifically, the configurations (including the numerals of functional blocks) of the WEB server 120 and client terminal 110 can be defined by the HDL descriptions, and the HDL descriptions can be logically combined to be imparted to ASIC or PLD, which allows the WEB server 120 and client terminal 110 to be produced.

Although a few embodiments have been illustrated and described, it would be appreciated by those skilled in the art that changes may be made in these embodiments without departing from the principles and spirit, the scope of which is defined in the claims and their equivalents.

What is claimed is:

1. An access outcome feedback method for determining a jump destination sorting ratio which is a ratio for jumping to each of a plurality of sites becoming a jump destination of a specified hyperlink and storing identical contents, the method comprising:
receiving a request to transmit data concerning a site becoming a jump destination of the hyperlink, the request being transmitted from a terminal apparatus accepting specification of the hyperlink;
selecting one site from the plurality of sites according to the jump destination sorting ratio when the transmission request is received;
transmitting data in which the selected site is specified as the jump destination to the terminal apparatus;
acquiring a download outcome of the contents, the download being performed by the terminal apparatus jumping to the one site according to the transmitted data;
determining whether a site whose download failure frequency is equal to or higher than a predetermined threshold exists in the plurality of sites based on the acquired download outcome; and
updating the jump destination sorting ratio to lower the ratio for jumping to the site whose download failure frequency is equal to or higher than the predetermined threshold, when the determination that the site whose download failure frequency is equal to or higher than the predetermined threshold exists is made in the determination.

2. The access outcome feedback method according to claim 1, wherein the determination determines whether a site whose download failure frequency in a predetermined period is equal to or higher than a predetermined threshold exists.

3. The access outcome feedback method according to claim 1, wherein the determination determines whether a site whose download failure frequency in a predetermined period is equal to or higher than a predetermined threshold exists, the predetermined period including a current clock time and going back to a past from the current clock time.

4. The access outcome feedback method according to claim 1, wherein the determination determines whether a site whose failure frequency is equal to or higher than a predetermined threshold exists in each site of the plurality of sites.

5. An access outcome feedback method for causing a downloadable computer to execute contents provided by a site published on a communication network, the method comprising:
outputting a request to transmit data concerning a site becoming a jump destination of a specified hyperlink to a server which is a computer apparatus on the communication network;
receiving data concerning a jump destination sorting ratio which is a ratio for jumping to each of a plurality of sites becoming the jump destination of the hyperlink and storing identical contents, the data being transmitted from the server in response to the output;
jumping to one site of the plurality of sites according to the received data;
downloading the contents from the jumped one site;
acquiring the download outcome; and
transmitting the acquired download outcome to the server.

6. A computer-readable recording medium in which a program for executing an access outcome feedback method is recorded, the access outcome feedback method determining a jump destination sorting ratio which is a ratio for jumping to each of a plurality of sites becoming a jump destination of a specified hyperlink and storing identical contents, the access outcome feedback method comprising:
receiving a request to transmit data concerning a site becoming a jump destination of the hyperlink, the request being transmitted from a terminal apparatus accepting specification of the hyperlink;
selecting one site from the plurality of sites according to the jump destination sorting ratio when the transmission request is received;
transmitting data in which the selected site is specified as the jump destination to the terminal apparatus;
acquiring a download outcome of the contents, the download being performed by the terminal apparatus jumping to the one site according to the transmitted data;
determining whether a site whose download failure frequency is equal to or higher than a predetermined threshold exists in the plurality of sites based on the acquired download outcome; and
updating the jump destination sorting ratio to lower the ratio for jumping to the site whose download failure frequency is determined to be equal to or higher than the predetermined threshold, when the determination that the site whose download failure frequency is equal to or higher than the predetermined threshold exists is made in the determination.

7. The computer-readable recording medium according to claim 6, wherein, in the access outcome feedback method, the determination determines whether a site whose download failure frequency in a predetermined period is equal to or higher than a predetermined threshold exists.

8. The computer-readable recording medium according to claim 6, wherein, in the access outcome feedback method, the determination determines whether a site whose download failure frequency in a predetermined period is equal to or higher than a predetermined threshold exists, the predetermined period including a current clock time and going back to a past from the current clock time.

9. The computer-readable recording medium according to claim 6, wherein, in the access outcome feedback method, the determination determines whether a site whose failure frequency is equal to or higher than a predetermined threshold exists in each site of the plurality of sites.

10. A computer-readable recording medium in which a program for executing an access outcome feedback method is recorded, the access outcome feedback method causing a downloadable computer to execute contents provided by a site published on a communication network, the access outcome feedback method comprising:
outputting a request to transmit data concerning a site becoming a jump destination of a specified hyperlink to a server which is a computer apparatus on the communication network;
receiving data concerning a jump destination sorting ratio which is a ratio for jumping to each of a plurality of sites becoming the jump destination of the hyperlink and storing identical contents, the data being transmitted from the server in response to the output;
jumping to one site of the plurality of sites according to the received data;
downloading the contents from the jumped one site;
acquiring the download outcome; and
transmitting the acquired download outcome to the server.

11. An access outcome feedback apparatus determining a jump destination sorting ratio which is a ratio for jumping to each of a plurality of sites becoming a jump destination of a specified hyperlink and storing identical contents, the method comprising:
receiving means for receiving a request to transmit data concerning a site becoming a jump destination of the hyperlink, the request being transmitted from a terminal apparatus accepting specification of the hyperlink;
selecting means for selecting one site from the plurality of sites according to the jump destination sorting ratio when the transmission request is received;
transmitting means for transmitting data in which the selected site is specified as the jump destination to the terminal apparatus;
acquiring means for acquiring a download outcome of the contents, the download being performed by the terminal apparatus jumping to the one site according to the transmitted data;
determining means for making a determination whether a site whose download failure frequency is equal to or higher than a predetermined threshold exists in the plurality of sites based on the acquired download outcome; and
updating means for updating the jump destination sorting ratio to lower the ratio for jumping to the site whose download failure frequency is equal to or higher than the predetermined threshold, when the determining means determines that the site whose download failure frequency is equal to or higher than the predetermined threshold exists.

12. The access outcome feedback apparatus according to claim 11, wherein the determining means makes a determination whether a site whose download failure frequency in a predetermined period is equal to or higher than a predetermined threshold exists.

13. The access outcome feedback apparatus according to claim 11, wherein the determining means makes a determination whether a site whose download failure frequency in a predetermined period is equal to or higher than a predetermined threshold exists, the predetermined period including a current clock time and going back to a past from the current clock time.

14. The access outcome feedback apparatus according to claim 11, wherein the determining means makes a determination whether a site whose failure frequency is equal to or higher than a predetermined threshold exists in each site of the plurality of sites.

15. A terminal apparatus which can download contents provided by a site published on a communication network, the terminal apparatus comprising:
an output for outputting a request to transmit data concerning a site becoming a jump destination of a specified hyperlink to a server which is a computer apparatus on the communication network;
a receiver for receiving data concerning a jump destination sorting ratio which is a ratio for jumping to each of a plurality of sites becoming the jump destination of the hyperlink and storing identical contents, the data being transmitted from the server in response to the output;
jumping means for jumping to one site of the plurality of sites according to the received data;
downloading means for downloading the contents from the jumped one site;
acquiring means for acquiring the download outcome; and
a transmitter for transmitting the acquired download outcome to the server.
